(19) United States
(12) Patent Application Publication
(10) Pub. No.: US 2013/0331136 A1
(43) Pub. Date: Dec. 12, 2013

(54) Method And Apparatus For Coordinated Beamforming

(71) Applicants: Kai Yang, Belle Mead, NJ (US); Doru Calin, Manalapan, NJ (US); Aliye Ozge Kaya, Chatham, NJ (US); Simon Yiu, Jersey City, NJ (US)

(72) Inventors: Kai Yang, Belle Mead, NJ (US); Doru Calin, Manalapan, NJ (US); Aliye Ozge Kaya, Chatham, NJ (US); Simon Yiu, Jersey City, NJ (US)

(21) Appl. No.: 13/538,669

(22) Filed: Jun. 29, 2012

Related U.S. Application Data
(60) Provisional application No. 61/656,789, filed on Jun. 7, 2012.

(51) Int. Cl. H04B 15/00; G06F 21/00

(52) U.S. Cl. 455/501; 726/22

(57) ABSTRACT

Various methods and devices are provided to improve wireless communications. In one method, a need for additional wireless service in a target area is detected (401). As part of a first-layer beamforming process, a signaling beam is directed (402) toward the target area. As part of a second-layer beamforming process, at least some inter-cell interference is canceled (403) in the target area. In another method, a wireless denial of service (WDoS) attack from a first wireless node is detected (501). A signaling beam is directed (502) toward the first wireless node to suppress signaling from the first wireless node. While suppressing this signaling, service is provided (503) to other wireless nodes.

### REFERENCE(S) TO RELATED APPLICATION(S)

The present application claims priority from a provisional application Ser. No. 61/656,789, entitled “METHOD AND APPARATUS FOR COORDINATED BEAMFORMING,” filed Jun. 7, 2012, which is commonly owned and incorporated herein by reference in its entirety.

### FIELD OF THE INVENTION

The present invention relates generally to communications and, in particular, to beamforming in wireless communication systems.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

Commercial wireless networks are designed to either provide ubiquitous mobile access across a large geographical area, for example, the 3G and 4G metro cellular networks or a hotspot area with dense users (such as the indoor systems, e.g. Femto, Pico, WiFi). For metro cell systems, the data traffic and the number of user equipment (UE) associated with a Base Station (BS) can be predicted by combining historical data with advanced statistical prediction methods. And the traffic imbalance among adjacent BSs could be compensated by load balancing techniques. Likewise, a hotspot wireless network is designed to deliver data to users over a small pre-determined area, e.g., a coffee shop. The traffic demand is unlikely to vary significantly over a short period of time.

The public safety wireless network differs significantly from other wireless networks in several aspects. First, a public safety network needs to cover a large geographical area, which is similar to the metro cellular system. Nevertheless, the traffic demand across neighboring cells could vary dramatically. For example, in case of a fire emergency, the data traffic in a small area will surge significantly because of the increasing traffic demand in this region. In addition, the hotspot area in the public safety network is random and unpredictable, which is different from the traditional WiFi systems. Furthermore, a public safety network requires much higher levels of reliability, resilience, and security than commercial wireless networks.

Historically the public safety networks rely on narrow band communication systems, e.g., Land Mobile Radio (LMR), for communication among first responders. Such systems have served the public safety agencies well by meeting their specific design requirements, such as stringent delay constraints. However, the narrow band systems are not suitable for high data rate applications, such as multimedia streaming. The revolutionary success of commercial broadband wireless networks has spurred significant interest in employing related technologies such as 3GPP Long Term Evolution (LTE) technologies to build a nationwide mobile broadband network for public safety entities. However, traditional cellular networks are designed for provisioning wireless services for either large geographic regions or pre-defined small hotspot areas. Thus, the direct application of commercial LTE technologies may not be the best solution for the public safety network [4].

Thus, new solutions and techniques that are able to address one or more of the issues encountered in public safety networks would meet a need and advance wireless communications generally.

### BRIEF DESCRIPTION OF THE DRAWINGS

FIG. 1 is a depiction of downlink beam patterns activated in a wireless network, in accordance with various embodiments of the present invention.

FIG. 2 is a depiction of uplink beam patterns activated in a wireless network, in accordance with various embodiments of the present invention.

FIG. 3 is a logic flow diagram of functionality in accordance with certain embodiments of the present invention.

FIG. 4 is a logic flow diagram of functionality in accordance with some embodiments of the present invention.

FIG. 5 is a logic flow diagram of functionality in accordance with other embodiments of the present invention.

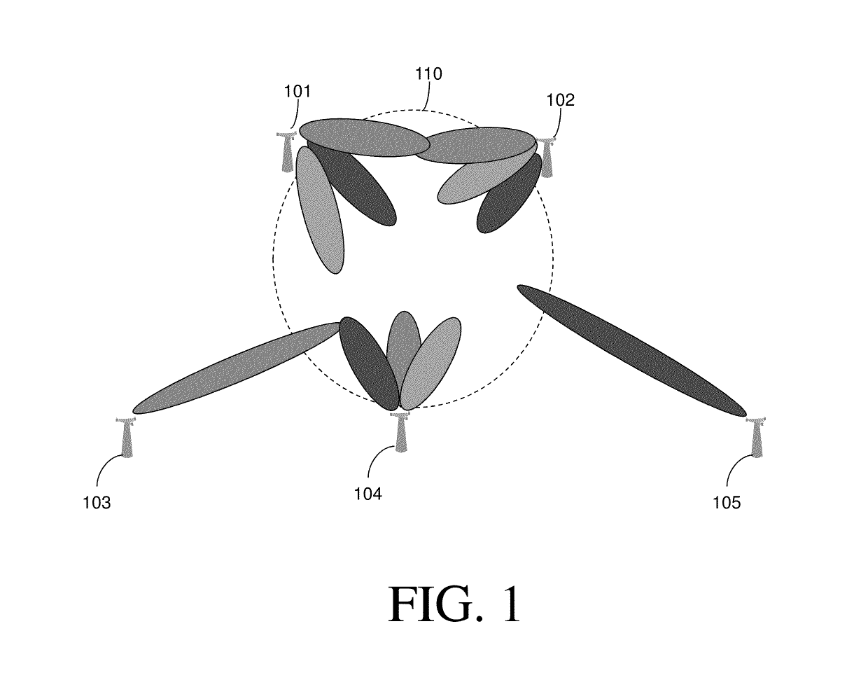

Specific embodiments of the present invention are disclosed below with reference to FIGS. 1-5. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY

Various methods and devices are provided to improve wireless communications. In one method, a need for additional wireless service in a target area is detected. As part of a first-layer beamforming process, a signaling beam is directed toward the target area. As part of a second-layer beamforming process, at least some inter-cell interference is canceled in the target area. An article of manufacture is also provided, the article comprising a processor-readable storage medium storing one or more software programs which when executed by one or more processors performs the steps of this method.

In another method, a wireless denial of service (WDoS) attack from a first wireless node is detected. A signaling beam is directed toward the first wireless node to suppress signaling from the first wireless node. While suppressing this signaling, service is provided to other wireless nodes. An article of manufacture is also provided, the article comprising a processor-readable storage medium storing one or more software programs which when executed by one or more processors performs the steps of this method.

A network equipment apparatus is also provided. The network equipment is configured to communicate with other equipment in a communication system and is operative to detect a need for additional wireless service in a target area. As part of a first-layer beamforming process, the network equipment is operative to direct a signaling beam toward the target area, and as part of a second-layer beamforming process, the network equipment is operative to cancel at least some inter-cell interference in the target area.

Another network equipment apparatus is also provided. This network equipment is configured to communicate with other equipment in a communication system and is operative to detect a wireless denial of service (WDoS) attack from a first wireless node and to direct a signaling beam toward the first wireless node to suppress signaling from the first wireless node. While suppressing signaling from the first wireless node, the network equipment is operative to provide service to other wireless nodes.

### DETAILED DESCRIPTION OF EMBODIMENTS

To provide a greater degree of detail in making and using various aspects of the present invention, a description of our approach to communications in public safety networks and a description of certain, quite specific, embodiments follows for the sake of example. FIGS. 1-3 are referenced in an attempt to illustrate some examples of specific embodiments of the present invention.

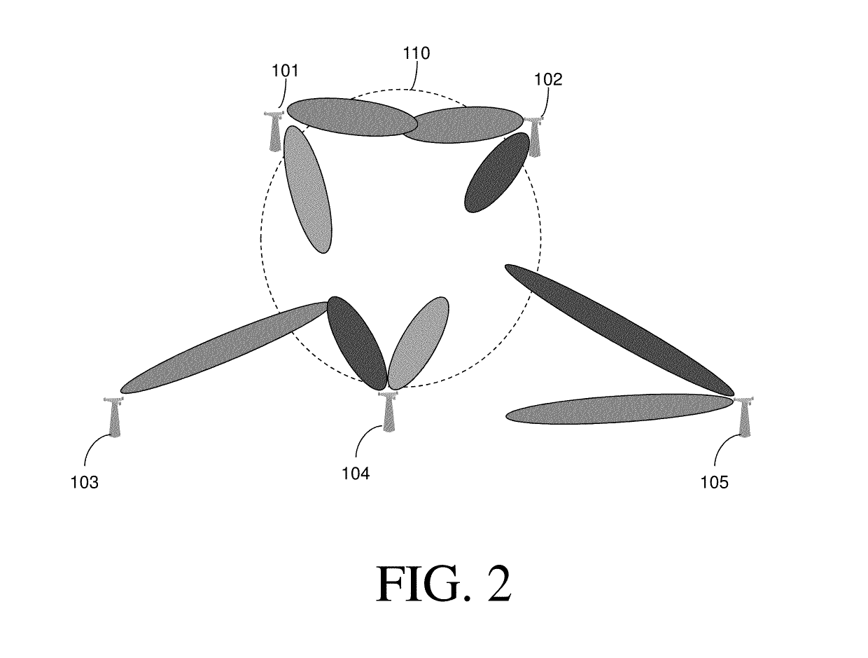

To cope with the aforementioned challenges, we propose a coordinated dual-layer beamforming (CoB) system for highly reliable and spectrum-efficient communications in public safety networks. We assume each BS is equipped with a beamforming antenna that is capable of choosing one or multiple beams from a set of pre-computed beamforming patterns according to the traffic condition. Such an approach could significantly enhance the system throughput and thereby increase the number of UEs that can be simultaneously connected. For example, as shown in FIGS. 1 and 2, whenever a fire emergency occurs in a specific geographic area 110, nearby BSs 101-105 will illuminate beams toward it. The beam pattern activated by each BS is determined by the physical distance between a BS and the target cell. If a BS is far away from the target cell, it will choose a beam with higher beamforming gain but narrower beam width. Also, we combine this beamforming approach with an advanced network MIMO approach to further suppress the interference and enhance the system-wide capacity. Some distinct features of the proposed approach are summarized below.

Fast response: A public safety network should be able to quickly respond to fire and medical emergencies and provide reliable data communications in a hot spot area with hundreds or even thousands of users. A CoB system could meet this demand by intelligently choosing a group of beamforming patterns and radiating them toward target areas. In doing so, the system can adaptively offer coverage to a hotspot area so as to guarantee necessary throughput performances of a selected group of users. Note that today's electric devices can switch the beams very quickly, therefore the CoB system is capable of accommodating a quickly increasing number of users in the hotspot area.

Flexibility: According to the Federal Communication Commission (FCC), part of the 700 MHz spectrum will be auctioned to private entities to encourage them to work with the public safety agencies to deploy and manage the network. Therefore, ideally the public network should be able to support non-emergency data communications as well. The CoB system could meet such demand by flexibly adapting the beam patterns used by each BS to serve users across different cells.

Resiliency: A beamforming antenna typically consists of a collection of antenna elements, and each of them could either work independently or jointly form beams. In case one of the antenna elements fails to work, the remaining elements could still work together to direct signals toward the desired users. A BS with traditional omni-antennas, by contrast, is more vulnerable to antenna element failures, which results in a coverage hole in the target area. In addition, in a CoB system, if a BS fails, the neighboring BSs could use an adjusted beam pattern with higher beamforming gain to provide the coverage.

Security: Security is a vital feature of the public safety network. A particular vulnerability of the wireless network is a potential wireless denial of service (WDoS) attack. In a WDoS attack, malicious nodes continuously bombard targeted BSs with various bogus requests and messages that may completely crash the wireless network [5]. Such a DoS attack can be mitigated by forming a proper beam to suppress the signal from malicious nodes and thereby allow most legitimate users to access the BS.

Energy efficiency: An omni-antenna has a uniform radiation pattern. A beamforming antenna, on the contrary, can radiate a signal toward only a selected group of users. In doing so, it can achieve similar throughput performance with much less power consumption.

Directional antennas have been widely used for both outdoor and indoor transmissions to enhance the coverage and throughput performance of commercial wireless networks [1], [2], [3], [6], [7]. Various theoretical and experimental studies have indicated that the beamforming technology is an effective means to mitigate wireless interference and thereby increase system performance. Beamforming technologies can also be combined with other smart resource allocation schemes, e.g., fractional frequency reuse, power control or hybrid ARQ schemes to further improve the throughput of a wireless system.

A standard approach to achieve the beamforming gain is to place a collection of antenna elements in a specific geometry, for example, circular, linear, or rectangular. The shape of the beam radiated by a BS is determined by the specific set of weights applied to the antenna elements. In doing so, each BS can direct the beam to target users so as to improve signal strength and reduce the interference against other users. The main lobe of a beamforming antenna represents the major direction of radiation. Ideally, a beamforming antenna directs the signal to only the target area, i.e., the direction of the main lobe. The beamwidth of the main lobe usually decreases with more antenna elements, providing a much narrower and focused beam. However, in practice, the antenna can not completely remove the undesired radiation in other directions, i.e., the side lobes, which may be quite significant as compared to the energy radiated from the main lobe.

Besides beamforming methods, a related technology to improve the link throughput, especially when the link Signal-to-Interference+Noise Ratio (SINR) is good, is Multi-Input-Multi-Output (MIMO) technology. As opposed to the beamforming technologies, MIMO technologies utilize the rich-scattering nature of the wireless channel and transmit different signals over different antenna ports. Note that each antenna port may consist of multiple antenna elements. If the channels between different pairs of transmitter and receiver antenna ports are sufficiently uncorrelated, i.e., there are many scatters in the environment, the approach can achieve a significant MIMO gain, i.e., a diversity or spatial multiplexing gain, and dramatically improve the link throughput.

Dual-layer beamforming technologies have been promoted as an effective way to achieve both the MIMO gain and the beamforming gain. In the downlink transmission, the dual-layer beamforming technologies allow the transmitter to realize two layers of pre-processing. The goal of the first layer is to perform the beamforming whereas the goal of the second layer is to achieve the MIMO gain.

In some of the proposed embodiments, a neighboring BS will radiate a signal toward an area where an emergency has occurred. This may result in strong inter-cell interference. In this case, coordinated multiple point transmission (CoMP) may help further suppress the strong inter-cell interference and enhance the user throughput, especially at the cell boundary. CoMP refers to a framework of tranmission/reception strategies that utilize geographically distributed antennas for coordinated data transmission and thereby reduce the inter-cell interference. Nodes participating in the cooperation are often required to exchange real-time information through the X2 interface. Coordinated beamforming (CB) and joint processing (JP) are two well-known realizations of the CoMP technologies. In a coordinated beamforming system, a UE receives information from only one BS while joint beamforming/precoding approaches are employed by neighboring BSs to cancel the inter-cell interference. The joint processing approach, in contrast, eliminates the interference by jointly transmitting information to a UE from multiple BSs. It has been shown that both schemes can significantly improve the system performance at the expense of extra data processing and transmission over the X2 interface. However, the realization of CoMP becomes increasingly difficult as the number of coordinating BSs increases, due to the errors in the channel feedback and the large amount of information that needs to be exchanged in real-time.

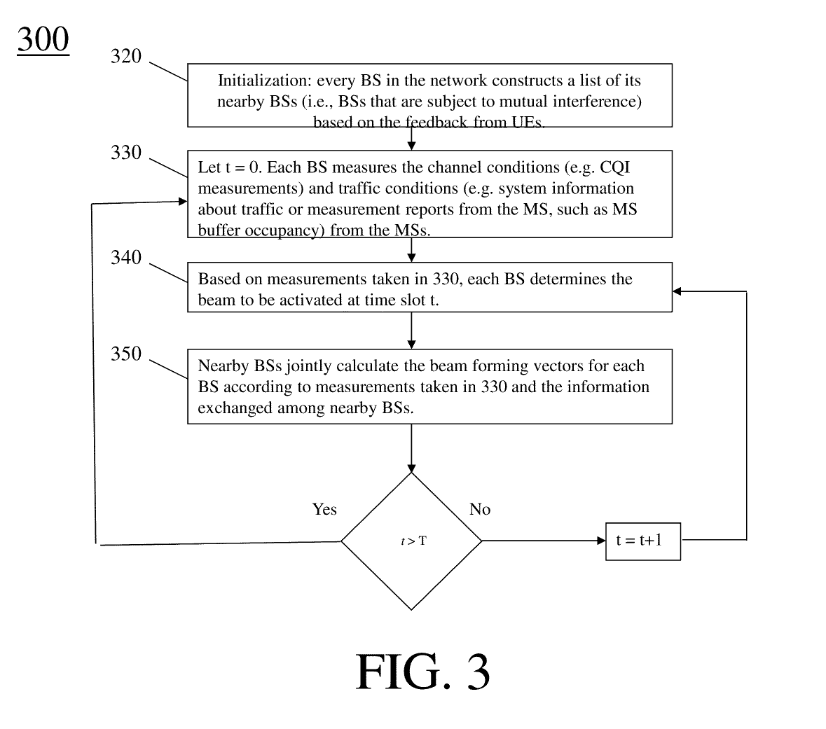

FIG. 3 is a logic flow diagram 300 of functionality in accordance with various embodiments of the present invention. At the initialization stage (320), one constructs a group of neighboring BSs, i.e., BSs that are subject to strong mutual interference. Note that the BSs pertaining to a group are not necessarily geographically adjacent to each other. In some embodiments, the level of interference between two BSs, can be measured by sending training sequences out from BSs to MSs. This mechanism can thereby support the construction of the group. Depending on the embodiment, training sequences may be system information transmitted over control channels (e.g. broadcast channels). Here, an MS reads and reports back to at least one BS the identity of other BSs from which the MS is able to receive system information.

After the initialization stage, every BS measures (330) the channel periodically for each T time slots to capture the dynamics of the channel. In some embodiments, the time interval, T, is a system parameter which can be optimized for best system performance and minimal overhead. Based on the channel conditions (e.g. using Channel Quality Information (CQI) measurements) and traffic conditions (e.g. system information about traffic or measurement reports from the MS, such as MS buffer occupancy), the BSs determine (340) the beam patterns to use for data transmission.

Illuminating multiple beams toward the same area may decrease the received signal-to-noise-plus-interference-ratio (SINR) at the UEs. Thus, in some embodiments of the present invention, a second-layer joint beamforming processing is employed to further suppress the resulting interference (350). For example, nearby BSs jointly calculate the beam forming vectors for each BS according to measurements taken in 330 and the information is exchanged among nearby BSs. Also, in some embodiments of the present invention, the second-layer beamforming is carried out on a per-user basis, i.e., neighboring BSs exchange information through the X2 interferences and calculate a joint beamforming vector for every UE according to the measured channel feedback information.

Note that although the above procedure is described for downlink transmissions (i.e., transmission from BSs to UEs), a similar mechanism can be employed for uplink (i.e., transmissions from UEs to BSs). For instance, one can envisage that the set of interferers for uplink and downlink are different, in which case, a group does not necessarily have the same members for downlink and uplink, as depicted for example in FIG. 1 (downlink) and FIG. 2 (uplink). The groups in uplink can be formed in similar way to downlink, by measuring appropriate uplink system information (e.g., sounding signals and uplink channel quality feedback).

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

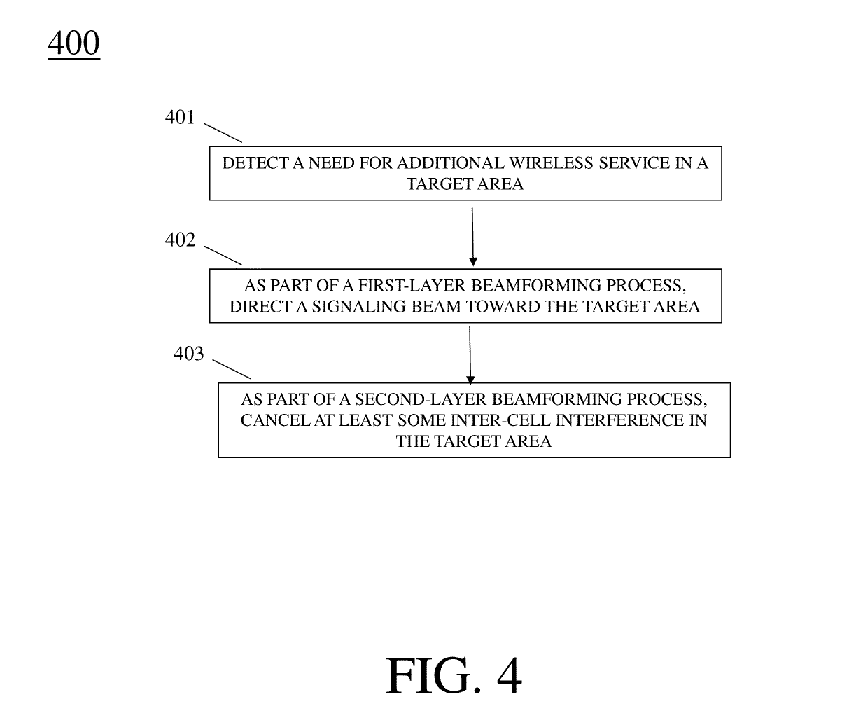

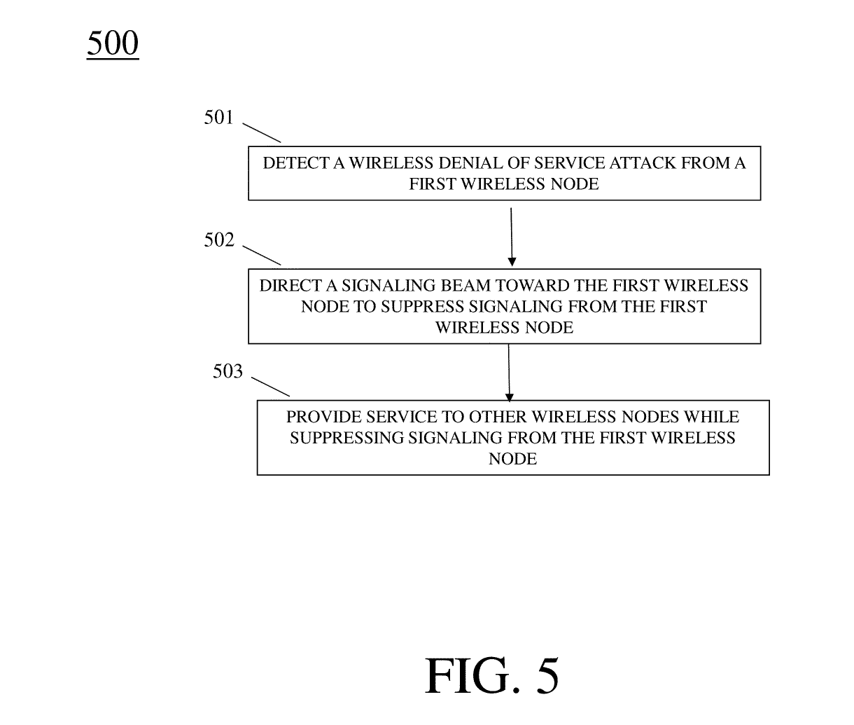

Aspects of embodiments of the present invention can be understood with reference to FIGS. 4 and 5. Diagram 400 of FIG. 4 is a logic flow diagram of functionality in accordance with various embodiments of the present invention. In the method depicted in diagram 400, a need for additional wireless service in a target area is detected (401). As part of a first-layer beamforming process, a signaling beam is directed (402) toward the target area, and as part of a second-layer beamforming process, at least some inter-cell interference is canceled (403) in the target area.

Many embodiments are provided in which the method and logic flow above may be modified. For example, in many embodiments detecting a need for additional wireless service in a target area includes detecting an emergency situation and/or a cell equipment failure affecting the target area. In some embodiments, performing the second-layer beamforming process includes facilitating coordinated multiple point transmission (CoMP) in providing wireless service for the target area. In some embodiments, performing the second-layer beamforming process includes performing joint beam scheduling with other base stations serving the target area. This joint beam scheduling may include calculating a joint beamforming vector on a per-user basis using instantaneous channel feedback information and/or measured channel feedback information.

Diagram 500 of FIG. 5 is a logic flow diagram of functionality in accordance with various embodiments of the present invention. In the method depicted in diagram 500, a wireless denial of service (WDoS) attack from a first wireless node is detected (501). A signaling beam is directed (502) toward the first wireless node to suppress signaling from the first wireless node. While suppressing this signaling, service is provided (503) to other wireless nodes.

Below is a list of references that are referred to above:
[1] Alcatel Lucent, IEEE S802.16m-08/487, “Grid-of-Beams (GoB) Based Downlink Multi-User MIMO,” Macau, China, May 7-May 12, 2008.
[2] Ericsson, R1-062282, “Schedule single vs. multiple beams per frame for E-UTRA,” Tallin, Estonia, Aug. 28-Sep. 1, 2006.
[3] P. Hosein and C. van Rensburg, “On the Performance of Downlink Beamforming with Synchronized Beam Cycles”, In VTC Spring, 2009.
[4] J. M. Peha, W. Johnston, P. Amodio and T. Peters, “The Public Safety Nationwide Interoperable Broadband Network: A New Model for Capacity, Performance and Cost”, available online at http://transition.fcc.gov/pshs/docs/releases/DOC-298799A1.pdf.
[5] K. Pelechrinis, M. Iliofotou, and S. V. Krishnamurthy, “Denial of Service Attacks in Wireless Networks: The Case of Jammers,” IEEE Communications Surveys & Tutorials, 13(2), pp. 245-257, May. 2011.
[6] X. Liu, A. Shethz, M. Kaminskyx, K. Papagiannakix, S. Seshany, and P. Steenkistey, “DIRC: increasing indoor wireless capacity using directional antennas” ACM SIGCOMM Computer Communication Review, pp. 171-182 August 2009.
[7] K. Sundaresan, K. Ramachandran, and S. Rangarajan, “Optimal beam scheduling for multicasting in wireless networks”, In Proceedings of MobiCom 2009.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method, comprising:
detecting a need for additional wireless service in a target area;
as part of a first-layer beamforming process, directing a signaling beam toward the target area;
as part of a second-layer beamforming process, canceling at least some inter-cell interference in the target area.

2. The method of claim 1, wherein detecting a need for additional wireless service in a target area comprises
detecting at least one of an emergency situation or a cell equipment failure affecting the target area.

3. The method of claim 1, wherein performing the second-layer beamforming process comprises
facilitating coordinated multiple point transmission (CoMP) in providing wireless service for the target area.

4. The method of claim 1, wherein performing the second-layer beamforming process comprises
performing joint beam scheduling with other base stations serving the target area.

5. The method of claim 4, wherein performing joint beam scheduling with other base stations serving the target area comprises
calculating a joint beamforming vector on a per-user basis using at least one of instantaneous channel feedback information or measured channel feedback information.

6. An article of manufacture comprising a processor-readable storage medium storing one or more software programs which when executed by a processor perform the steps of the method of claim 1.

7. A method, comprising:
detecting a wireless denial of service (WDoS) attack from a first wireless node;
directing a signaling beam toward the first wireless node to suppress signaling from the first wireless node;
providing service to other wireless nodes while suppressing signaling from the first wireless node.

8. An article of manufacture comprising a processor-readable storage medium storing one or more software programs which when executed by a processor perform the steps of the method of claim 7.

9. Network equipment in a communication system, the network equipment being configured to communicate with other equipment in the system, wherein the network equipment is operative
to detect a need for additional wireless service in a target area,
as part of a first-layer beamforming process, to direct a signaling beam toward the target area, and
as part of a second-layer beamforming process, to cancel at least some inter-cell interference in the target area.

10. The network equipment of claim 9, wherein being operative to detect a need for additional wireless service in a target area comprises
being operative to detect at least one of an emergency situation or a cell equipment failure affecting the target area.

11. The network equipment of claim 9, wherein being operative to perform the second-layer beamforming process comprises
being operative to facilitate coordinated multiple point transmission (CoMP) in providing wireless service for the target area.

12. The network equipment of claim 9, wherein being operative to perform the second-layer beamforming process comprises
being operative to perform joint beam scheduling with other network equipment serving the target area.

13. The network equipment of claim 12, wherein being operative to perform joint beam scheduling with other base stations serving the target area comprises
being operative to calculate a joint beamforming vector on a per-user basis using at least one of instantaneous channel feedback information or measured channel feedback information.

14. Network equipment in a communication system, the network equipment being configured to communicate with other equipment in the system, wherein the network equipment is operative
to detect a wireless denial of service (WDoS) attack from a first wireless node,
to direct a signaling beam toward the first wireless node to suppress signaling from the first wireless node, and
to provide service to other wireless nodes while suppressing signaling from the first wireless node.
